(19) United States
(12) Patent Application Publication
(10) Pub. No.: US 2026/0331340 A1
(43) Pub. Date: Oct. 22, 2026

(54) MAGNET WIRE WITH POLYIMIDE INSULATION HAVING ADDITIVES TO PROVIDE RESISTANCE TO AUTOMATIC TRANSMISSION FLUID

(71) Applicant: Essex Solutions USA LLC, Atlanta, GA (US)

(72) Inventor: Shengqing Xu, Fort Wayne, IN (US)

(73) Assignee: Essex Solutions USA LLC, Atlanta, GA (US)

(21) Appl. No.: 19/640,897

(22) Filed: Apr. 7, 2026

Related U.S. Application Data
(60) Provisional application No. 63/792,037, filed on Apr. 21, 2025.

(51) Int. Cl. H01F 5/06; C08G 73/10; C08K 5/13; C08K 5/3417; C08K 5/3492; C08K 5/41; H01B 3/30

(52) U.S. Cl. CPC H01F 5/06; C08G 73/1071; C08K 5/13; C08K 5/3417; C08K 5/34924; C08K 5/41; H01B 3/306

(57) ABSTRACT

A magnet wire comprising: a conductor; and at least one insulation layer formed around the conductor, the insulation layer comprising: a base polyimide material; and one or more additives incorporated into the base polymeric material, the one or more additives comprising at least one unsaturated C═C-containing compound, wherein the one or more additives enhance resistance to automatic transmission fluid relative to a control insulation layer formed solely from the base polyimide material.

### CROSS-REFERENCE TO RELATED APPLICATION

This application claims priority to U.S. Provisional Application No. 63/792,037, filed on Apr. 21, 2025 and entitled “Magnet Wire with Polyimide Insulation having Additives to Provide Resistance to Automotive Transmission Fluid,” which is incorporated by reference herein in its entirety.

### TECHNICAL FIELD

Embodiments of the disclosure relate generally to magnet wire and, more particularly, to magnet wire having polyimide insulation incorporating one or more additives that provide or enhance resistance to automatic transmission fluid.

### BACKGROUND

Magnet wire, also referred to as winding wire or magnetic winding wire, is utilized in a wide variety of electric machines and devices, such as inverter drive motors, motor starter generators, transformers, etc. Typically, magnet wire is constructed by applying electrical insulation to a metallic conductor, such as a copper, aluminum, or alloy conductor. The insulation provides for electrical integrity and prevents shorts in the magnet wire. Certain magnet wire includes enamel insulation applied in successive layers and cured in an oven. Enamel layers are typically applied as a varnish containing thermosetting polymeric material suspended in solvent, and the heat curing removes substantially all the solvent and leaves a solid polymeric layer.

Polyimide (“PI”) is a thermosetting polymeric material utilized to form enamel insulation for magnet wire used in high performance applications, such as in electric vehicles (“EVs”), which typically comprise battery electric vehicles (“BEVs”), hybrid electric vehicles (“HEVs”), plug-in hybrid electric vehicles (“PHEVs”), and in other high performance application such as automotive, maritime, and aviation applications. In particular, magnet wire incorporating PI insulation has relatively high temperature and electrical performance properties compared to polyvinyl or polyesters, thereby permitting enhanced performance of an electric motor or electric appliance incorporating the magnet wire.

However, PI insulation may crack, degrade, decompose, or break down when utilized in applications in which the insulation is exposed to automatic transmission fluid (“ATF”). ATF is primarily composed of a base oil and several additives. The base oil tends to comprise hydrocarbons that have a high boiling point, such as mineral oils or synthetic oils. The additives are typically included to improve performance properties in automatic transmissions. For example, thermal stabilizers may be added to mitigate overheating of the ATF. Without thermal stabilizers, the ATF may overheat during normal use. Overheating can lead to ATF oxidation, which can reduce the ATF's viscosity, create deposits in the transmission system, and generally degrade the ATF's lubricating and torque transfer properties. Such degradation can contribute to further overheating and ultimately result in the mechanical parts in a transmission system (e.g., gears, clutches, bearings, impeller, stator, and turbine elements in the torque converter, etc.) directly moving or grinding against each other, which can greatly accelerated wear.

However, certain thermal stabilizers incorporated into ATF, have been found to significantly accelerate degradation or decomposition of PI insulation over time. When PI is used as a magnet wire insulation layer, such premature breakdown can lead to short circuits, catastrophic component failure, and damage to connected equipment.

### SUMMARY

Accordingly, there is an opportunity for improved magnet wire having polyimide (“PI”) insulation that incorporates one or more additives that provide resistance to ATF. In particular, there is an opportunity for improved magnet wire having PI insulation formed with one or more additives that slow down and/or prevent polymer chain breaking and/or polymer network breaking (i.e., the polymer network structure formed by a combination of PI and the additives) due to contact with ATF, to thereby limit cracking or degradation of the PI insulation in the presence of, or after exposure to ATF.

Various embodiments of the present disclosure are directed to magnet wire that includes a conductor and at least one layer of PI insulation formed around the conductor. A wide variety of suitable insulation systems may be formed around the conductor. Certain insulation systems may include one or a plurality of thermosetting PI layers. Other insulation systems may combine one or more PI layers with one or more other insulation layers, such as layers formed from other thermosetting materials (e.g., polyesters, PI copolymers, polyamides, polyurethanes, aromatic polyethers, silicone polymers, and the like). According to an aspect of the disclosure, at least one layer of PI insulation may incorporate one or more additives that function to enhance ATF resistance. For example, one or more additives may be incorporated into an outermost PI insulation layer. As a result, cracking, degradation, and/or breakdown of the PI insulation as a result of exposure to ATF may be limited, slowed, and/or prevented.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIGS. 1A-1D are cross-sectional views of example magnet wire constructions that include polyimide insulation incorporating one or more additives that enhance resistance to ATF, according to illustrative embodiments of the disclosure.

FIG. 2. is a cross-sectional schematic representation of a vertically oriented enameling equipment assembly, which applies enamel coating around a conductor through an applicator and dies.

### DETAILED DESCRIPTION

The following detailed description of the preferred embodiments is presented for illustrative and descriptive purposes and is not intended to be exhaustive or to limit the scope and spirit of the invention. The embodiments were selected and described to best explain the principles of the invention and its practical application. One of ordinary skill in the art will recognize that many variations can be made to an invention disclosed in this specification without departing from the scope and spirit of the invention.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various exemplary embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference of discussion is not an admission that the document, act or item of knowledge or any combination thereof was at the priority dates, publicly available, known to the public, part of common general knowledge, or otherwise constitutes prior art under the applicable statutory provisions; or is know to be relevant to an attempt to solve any problem with which this specification is concerned.

Although the drawings represent embodiments of various features and components according to the present disclosure, the drawings are not necessarily to scale and certain features may be exaggerated to better illustrate embodiments of the present disclosure, and such exemplifications are not to be construed as limiting the scope of the present disclosure.

Except as otherwise expressly stated herein, the following rules of interpretation apply to this specification: (a) all words used herein shall be construed to be of such gender or number (singular or plural) as such circumstances require; (b) the antecedent term “about” applied to a recited range of values denotes an approximation with the deviation in the range of values known or expected in the art from the measurements; (c) the words, “herein,” “hereby,” “hereto,” “hereinbefore,” and “hereinafter,” and words of similar import, refer to this specification in its entirety and not to any particular paragraph, claim, or other subdivision, unless otherwise specified; (d) descriptive headings are for convenience only and shall not control or affect the meaning of construction of part of the specification; and (e) “or” and “any” are not exclusive and “include” and “including” are not limiting. Further, the terms, “comprising,” “having,” “including,” and “containing” are to be construed as open-ended terms (i.e., meaning, “including but not limited to”). Furthermore, conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

References in the specification to, “one embodiment,” “an embodiment,” “an exemplary embodiment,” etc., indicate that the embodiment described may include a particular feature, structure, or characteristic. Moreover, such phrases are not necessarily referring to the same embodiment.

The terms “upstream” and “downstream” refer to relative positions in a process, with “upstream” referring to structures or process steps that occurred prior to or are positioned ahead of the referenced process step or structure and “downstream” referring to structures or process steps that occur after or are positioned after the referenced process step or structure.

To the extent necessary to provide descriptive support, the subject matter and/or text of the appended claims are incorporated herein by reference in their entirety.

Recitation of ranges of values herein are merely intended to serve as a shorthand method of referring individually to each separate value falling within the range of any subranges therebetween, unless otherwise clearly indicated herein. Each separate value within a recited range is incorporated into the specification or claims as if each separate value were individually recited herein. All subranges are also included. The upper and lower limits of any ranges and subranges are also included therein, subject to any specifically and expressly excluded limit in the stated range. As used herein, the term “about” means plus or minus 10% of the numerical value of the number with which it is being used.

The term, “polyimide” or the abbreviation “PI” may be used interchangeably herein. For purposes of this disclosure, a “polyimide insulation layer” or a “PI insulation layer” may include a layer that is formed utilizing only PI as a thermosetting polymeric resin material or, alternatively, may include a polyimide copolymer. It will be appreciated that in certain exemplary embodiments, a polyimide insulation layer on a magnet wire may include about 0.1% to about 5% (weight percentage) of residual polyimide precursor, which may exist as a weak solid in the cured layer. Residual polyimide precursor is a polyimide precursor that did not catalyze into PI during the PI formation process, and it can include but is not limited to polyamic acid. Suitable PI copolymers include, but are not limited to, polyamide-imide, polyester-imide, polysiloxane-imide, polyether-imide, and/or polyurethane-imide, and other similar copolymers known to those skilled in the art. Additionally, a polyimide insulation layer may include suitable additives and/or filler materials.

Without limiting the scope of the disclosure, the inventor has discovered that certain thermal stabilizers incorporated into ATF, such an octadecanoic acids, which are also known as stearic acids, (including OCA-amine (i.e., N′-[2-[2-(aminoethylamino)ethylamino]ehyl]ethane-1,2-diamine octadecanoic acid), isooctadecanoic acids (including isooctadecanoic acid, reaction products with tetraethylenepentamine (i.e., CAS Registry No. 68784-17-8)) and/or other amine or alkaline antioxidants, have been found to significantly accelerate degradation or decomposition of PI insulation over time, especially at elevated temperatures in presence of water or moisture. For example, when magnet wire having PI insulation is positioned in ATF at 150 degrees Celsius (“°C”) for approximately 1000 hours, antioxidants such as OCA-amine catalyzed PI hydrothermal decomposition to break the polymer chains and lead to destruction of PI materials. When PI is used as a magnet wire insulation layer, such premature breakdown can lead to short circuits, catastrophic component failure, and damage to connected equipment.

As desired in various embodiments, a wide variety of suitable additives and/or combinations of additives may be incorporated into one or more PI insulation layers and/or used in the formation of one or more PI insulation layers (i.e., incorporated into materials used to form insulation layers) to enhance ATF resistance. In certain embodiments, one or more additives may be incorporated (e.g., mixed into, blended into, laminated onto, coated on, chemically reacted into, etc.) into a single PI insulation layer. In other embodiments, one or more additives may be incorporated into a plurality of PI insulation layers. In yet other embodiments, one or more additives may be incorporated into both one or more PI insulation layers and one or more insulation layers formed from other materials (e.g., a topcoat layer formed around one or more PI layers from polyamideimide or another suitable thermosetting material).

According to an aspect of the disclosure, the additives utilized to enhance ATF resistance may include one or more unsaturated C═C-containing chemical compounds in molecules. In other words, one or more additives may include compounds having at least one double bond (C═C) between carbon atoms while the carbon atoms in the double bond are not bonded to the maximum number of hydrogen atoms. As desired in various embodiments, an unsaturated C═C-containing compound utilized as an additive may have a boiling point above approximately 150 °C at ambient conditions (i.e., about 21 °C to about 25 °C at about one atmosphere of pressure). In certain embodiments, the additives may include one or more compounds comprising a maleimide, a nadimide, and/or an itaconimide. In further exemplary embodiments, the additives may include one or more compounds comprising one or more vinyl and/or allyl functional groups. For example, one or more allyls (as defined below) may be utilized as additives. In other embodiments, the additives may include one or more bismaleimides (“BMI”), bisnadimides (“BNI”), methylnadimides (“MNI”), bismethylnadimides (“BMNI”), N-arylitaconimides (“NAI”) monomers, and/or bisitaconimide (“BII”) materials.

For the purposes of this disclosure, an unsaturated C═C-containing compound that is selected from the group consisting essentially of: a maleimide, a nadimide, and an itaconimide, shall be known as an “ATF-resistant compound.” Furthermore for the purpose of this disclosure, an unsaturated C═C-containing compound comprising a vinyl or allyl functional group shall be known as a “compound with the ATF-resistant functional group.” Unless otherwise stated, the term, “ATF-resistant additive” includes both ATF-resistant compounds and compounds with ATF-resistant functional groups. In certain exemplary embodiments, ATF-resistant additives desirably have a boiling point above approximately 150 °C at ambient conditions (i.e., about 21 °C to about 25 °C at about one atmosphere of pressure).

### Non-Limiting Examples of ATF-Resistant Additives.

For purposes of this disclosure, the term “allyl” or “allyl functional group” shall mean any suitable unsaturated hydrocarbon containing an allyl group having the structural formula —CH₂—HC═CH₂. Allyls may include allyl isocyanurate and allyl cyanurate. Examples of suitable allyls include, but are not limited to triallyl isocyanurate (“TAIC”) (CAS No. 1025-15-6); trimethallyl isocyanurate (“TMAIC”); triallyl cyanurate (“TAC”); triallyl trimellitate (“TATM”); tris[2-(acryloyloxy)ethyl]isocyanurate; trimethallyl isocyanurate (“TMAIC”); 2,2′-diallyl-bisphenol A (CAS No. 1745-89-7); and the like. TAIC and TMAIC have been found to be particularly useful additives.

For purposes of this disclosure, the term “bismaleimide” or “bismaleimides” shall mean any suitable unsaturated hydrocarbon containing two maleimide groups connected by nitrogen atoms via a linker, wherein the maleimide group generally have the structural formula —H2C₂(CO)₂NH—. Bismaleimides may include bismaleimides (“BMI”)- and bisnadimide (“BNI”)-terminated monomers and oligomers. Further, the terms “bismaleimide” and “dimaleimide” are used interchangeably in this disclosure. Likewise, the terms “bisnadimide” and “dinadimide” are used interchangeable in this disclosure.

The maleimide monomers in the bismaleimdes may include N-aliphatic maleimides. Examples of suitable maleimide monomers include: to N-cyclohexyl maleimide; N-vinyl maleimide; N-ally maleimide; N-phenyl maleimide; N-biphenyl maleimide; N-benzophonone maleimide, N-(4-vinylphenyl)maleimide; N-(p-methylphenyl) maleimide; N-benzyl maleimide; and other suitable N-aromatic maleimides known to those skilled in the art.

The nadimide monomers in the bisnadimides may include N-aliphatic nadimides. Examples of suitable nadimide monomers include: N-cyclohexyl nadimide; N-vinyl nadimide; N-ally nadimide; N-phenyl nadimide; N-biphenyl nadimide; N-benzophonone nadimide, N-(4-vinylphenyl) nadimide; N-(p-methylphenyl) nadimide; N-benzyl nadimide; and other suitable N-aromatic nadimides known to those skilled in the art.

Examples of suitable bismaleimides (“BMI”) include: diphenylmethane bismaleimide (“BMIM”); diphenylsulfone bismaleimide (“DDS/BMI”); phenylene bismaleimide (“PDA/BMI”); bis(aminophenoxyphenyl)propane bismaleimide (“BAPP/BMI”); oxydianiline bismaleimide (“ODA/BMI”); bismaleimidodimethylbiphenyl (“TLD/BMI”); 1,1′-(3,3′-dimethoxyl-1,1′-biphenyl-4,4′-diyl)bismaleimide (“DAS/BMI”); bis(aminophenoxy)benzene bismaleimide (“APB/BMI”); bis(maleimidophenoxy) biphenyl (“BABP/BMI”); diaminodiphenyldetone bismaleimide (“DABP/BMI”); diaminodiphenyl sulfide bismaleimide; bis(maleimido) biphenyl; bis(diaminodiphenylisopropylidimine)benzene bismaleimide; and other suitable bismaleimides having high thermal resistance known to those skilled in the art. Phenylene bismaleimide, diphenylsulfone bismaleimide, bis(maleimidophenoxy)biphenyl, bis(maleimido)biphenyl, bismaleimidodimethylbiphenyl, and diphenylmethane bismaleimide have been found to be particularly useful additives.

Examples of suitable bisnadimides (“BNI”) include: N-cyclohexyl nadimide; N-vinyl nadimide; N-ally nadimide; N-phenyl nadimide; N-biphenyl nadimide; N-benzophonone nadimide, N-(4-vinylphenyl) nadimide; N-(p-methylphenyl) nadimide; N-benzyl nadimide; and other suitable N-aromatic nadimides known to those skilled in the art; diphenylmethane bisnadimide (“BMIN”); diphenylsulfone bisnadimide (“DDS/BNI”); phenylene bisnadimide (“PDA/BNI”); bis(aminophenoxyphenyl)propane bisnadimide (“BAPP/BNI”); oxydianiline bisnadimide (“ODA/BNI”); bisnadimidodimethylbiphenyl (“TLD/BNI”); 1,1′-(3,3′-dimethoxyl-1,1′-biphenyl-4,4′-diyl)bisnadimide (“DAS/BNI”); bis(aminophenoxy)benzene bisnadimide (“APB/BNI”); bis(nadimidophenoxy) biphenyl (“BABP/BNI”); diaminodiphenyldetone bisnadimide (“DABP/BNI”); diaminodiphenyl sulfide bisnadimide; bis(nadimideo) biphenyl; bis(diaminodiphenylisopropylidimine)benzene bisnadimide; N,N′-(1,4-phenylene)dinadimide (“PPD/BNI”); 4,4′-bisnadimido-2,2′-dimethylbiphenyl (“MTLD/BNI”); 4,4′-bis(4-nadimidophenyl)ether (“ODA/BNI”); 4,4′-bis(4-nadimidophenyl)ether (“ODA/BNI”); and other suitable bisnadimides having high thermal resistance known to those skilled in the art. N,N′-(1,4-phenylene)dinadimide (“PPD/BNI”), 4,4′-bisnadimido-2,2′-dimethylbiphenyl (“MTLD/BNI”), 4,4′-bis(4-nadimidophenyl)ether (“ODA/BNI”), 4,4′-bis(4-nadimidophenyl)ether (“ODA/BNI”) have been found to be particularly useful additives.

Examples of suitable methylnadimides (“MN”) include: N-cyclohexyl methylnadimide; N-vinyl methylnadimide; N-ally methylnadimide; N-phenyl methylnadimide; N-biphenyl methylnadimide; N-benzophonone methylnadimide, N-(4-vinylphenyl) methylnadimide; N-(p-methylphenyl) methylnadimide; N-benzyl methylnadimide; and other suitable N-aromatic methylnadimides known to those skilled in the art.

Examples of suitable bismethylnadimides (“BMNI”) include: diphenylmethane bismethylnadimide (“BMIMN”); diphenylsulfone bismethylnadimide (“DDS/BMNI”); phenylene bismethylnadimide (“PDA/BMNI”); bis(aminophenoxyphenyl)propane bismethylnadimide (“BAPP/BMNI”); oxydianiline bismethylnadimide (“ODA/BMNI”); bismethylnadimidodimethylbiphenyl (“TLD/BMNI”); 1,1′-(3,3′-dimethoxyl-1,1′-biphenyl-4,4′-diyl)bismethylnadimide (“DAS/BMNI”); bis(aminophenoxy)benzene bismethylnadimide (“APB/BMNI”); bis(methylnadimidophenoxy) biphenyl (“BABP/BMNI”); diaminodiphenyldetone bismethylnadimide (“DABP/BMNI”); diaminodiphenyl sulfide bismethylnadimide; bis(methylnadimideo) biphenyl; bis(diaminodiphenylisopropylidimine)benzene bismethylnadimide; and other suitable bismethyl nadimides known to those skilled in the art.

Examples of suitable N-arylitaconimide (“NAI”) monomers include: N-phenylitaconimide; N-(4-methoxyphenyl)itaconimide; and other suitable N-arylitaconimides known to those skilled in the art.

Examples of suitable bisitaconimides (“BII”) include: diphenylmethane bisitaconimide (“BMII”); diphenylsulfone bisitaconimide (“DDS/BII”); phenylene bisitaconimide (“PDA/BII”); bis(aminophenoxyphenyl)propane bisitaconimide (“BAPP/BII”); oxydianiline bisitaconimide (“ODA/BII”); bisitaconimidodimethylbiphenyl (“TLD/BII”); 1,1′-(3,3′-dimethoxyl-1,1′-biphenyl-4,4′-diyl)bisitaconimide (“DAS/BII”); bis(aminophenoxy)benzene bisitaconimide (“APB/BII”); bis(itaconimidophenoxy) biphenyl (“BABP/BII”); diaminodiphenyldetone bisitaconimide (“DABP/BII”); diaminodiphenyl sulfide bisitaconimide; bis(itaconimido) biphenyl; bis(diaminodiphenylisopropylidimine)benzene bisitaconimide; and other suitable bisitaconimides known to those skilled in the art.

Structural isomers of any of the foregoing are considered to be within the scope of this disclosure. Combinations of any of the foregoing are also considered to be within the scope of this disclosure. A wide variety of other unsaturated C═C-containing compound suitable additives which could enhance the properties of the polyimide matrix by their reactions or polymerizations with the C═C group and other functional groups in the molecules may be utilized in addition to those set forth above as non-limiting examples are all included in the definition of “ATF-resistant additive” unless otherwise expressly stated.

In certain embodiments, a single additive for enhancing ATF resistance may be utilized in the PI insulation layer. In other embodiments, a combination of additives or a mixture or blend of multiple additives may be utilized in the PI insulation layer. In the event that a combination of additives is incorporated, any suitable blending ratio of additives may be utilized. Further, one or more additives may be selected based upon a wide variety of suitable characteristics as desired in various embodiments.

Additionally, any suitable loading factors of additives may be utilized as desired. In other words, any suitable weight percentage of additives may be incorporated into a PI material used to form an insulation layer. In certain embodiments, an additive (or a combination of additives) may constitute between approximately 0.3 percent (0.3%) and approximately forty percent (40.0%) by weight of a formed insulation layer. In other embodiments, an additive (or a combination of additives) may constitute between approximately 0.5 percent (0.5%) and approximately twenty percent (20.0%) by weight of an insulation layer. In various embodiments, the additive(s) may constitute approximately 0.3, 0.5, 1.0, 3.0, 5.0, 7.0, 10.0, 15.0, 20.0, 25.0, 30.0, 35.0 or 40.0 percent by weight of an insulation layer, a weight percentage included in a range between any two of the above values, or a weight percentage included in a range bounded on the maximum end by one of the above values. Additionally, different loading factors may be utilized in conjunction with different types of additives. For example, an allyl additive may be used with a preferred loading factor between approximately 0.3% and approximately 30.0% while a bismaleimide additive may be used with a preferred loading factor between approximately 0.3% and approximately 10.0%. It will be appreciated that other suitable loading factors may be used as desired.

In operation, one or more additives may be mixed, blended, or otherwise incorporated into a suitable PI-containing varnish that is utilized to form a magnet wire insulation layer. For example, the additive(s) may be incorporated into a polyamic acid or PI precursor in the presence of solvent(s). One example of a polyamic acid is an acid prepared from pyromellitic dianhydride (“PMDA”) and 4,4′-oxydianiline (“ODA”) in the presence of solvents (e.g., N-methylpyrrolidone or “NMP”, dimethylacetamide or “DMAc”, etc.). Other suitable materials may be utilized as dianhydride and diamine materials in order to form a polyamic acid. Additionally, a wide range of other suitable solvents and/or solvent blends may be utilized. The varnish may be applied to a magnet wire and cured (e.g., heat cured, etc.) in order to evaporate the solvent and form a solid polymeric PI layer containing the additive(s). In certain embodiments, the PI layer may be cured at a temperature greater than 250 °C.

As a result of incorporating one or more additives into the PI insulation layers (and/or other insulation layers), the magnet wire and its insulation system may have enhanced resistance to ATF. In certain embodiments, the additive(s) may provide enhanced resistance to one or more antioxidants incorporated into ATF, such as an OCA-amine. As a result, the PI insulation may exhibit reduced hydrothermal decomposition, breakdown in the PI polymer chain, and/or breakdown of the polymer network formed by the combination of the PI and the additive(s). Further, cracking and/or degradation of the PI insulation as a result of exposure to ATF may be reduced, limited, or prevented relative to PI insulation that does not incorporate the additive(s).

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

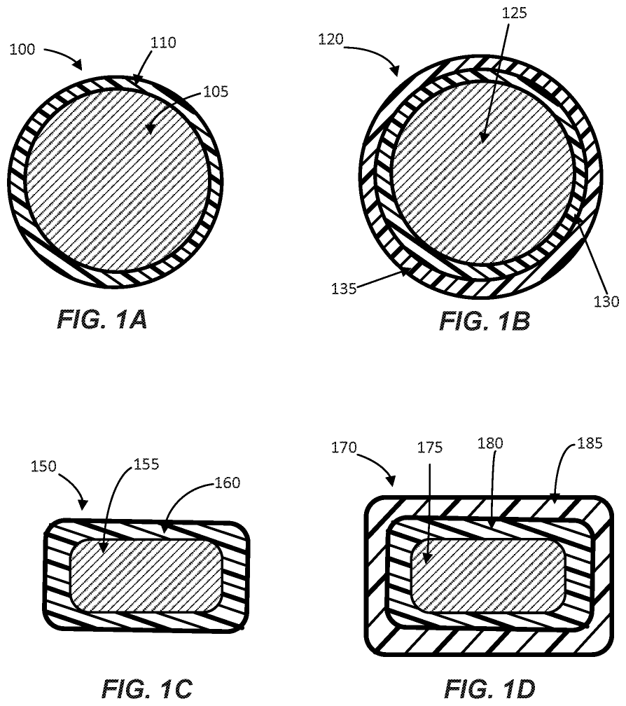

FIGS. 1A-1D illustrate cross-sectional views of example magnet wire constructions that include PI insulation incorporating one or more additives that enhance resistance to ATF. In particular, FIG. 1A illustrates a cross-sectional view of an example magnet wire having a round or circular cross-sectional shape in which a single layer of insulation 110 (which may include sublayers) is formed around a conductor 105. FIG. 1B illustrates another example magnet wire 120 having a round cross-sectional shape. The magnet wire 120 may include a conductor 125 and multiple layers 130, 135 of insulation formed around the conductor 125. In other words, the magnet wire 120 may include a basecoat insulation layer 130 formed around the conductor 125, and at least one additional layer of insulation (e.g., topcoat layer 135) formed around the basecoat 130. Although a single additional layer of insulation 135 is illustrated in FIG. 1B, any suitable number of insulation layers may be formed around a basecoat layer 130. For example, a magnet wire 120 may include a basecoat insulation layer, a midcoat insulation layer, and a topcoat insulation layer. In other embodiments, more than three insulation layers may be formed around a magnet wire.

FIG. 1C illustrates an example magnet wire 150 having a rectangular cross-sectional shape in which a single layer of insulation 160 (which may include sublayers) is formed around a conductor 155. FIG. 1D illustrates another example magnet wire 170 having a rectangular cross-sectional shape. Similar to the magnet wire 120 of FIG. 1B, the magnet wire 170 of FIG. 1D may include a conductor 175 and first and second layers 180, 185 of insulation formed around the conductor 175. In other words, the magnet wire 170 may include a basecoat insulation layer 180 formed around the conductor 175, and at least one additional layer of insulation (e.g., topcoat layer 185) formed around the basecoat 180. Any number of additional layers of insulation may be utilized as desired. For example, a magnet wire 170 may include a basecoat insulation layer, a midcoat insulation layer, and a topcoat insulation layer. In other embodiments, more than three insulation layers may be formed around a magnet wire.

The insulation of the example magnet wire constructions 100, 120, 150, 170 illustrated in FIGS. 1A-1D may include at least one layer of thermosetting polyimide enamel. For constructions that include a plurality of insulation layers (e.g., constructions 120, 170), a plurality of PI layers may be utilized or, alternatively, at least one PI layer may be combined with one or more layers formed from other suitable insulation materials and/or combinations of materials. Indeed, as described in greater detail below, magnet wire may be formed with a wide variety of suitable insulation systems. According to an aspect of the disclosure, at least one of the insulation layers is formed as a PI layer that incorporates one or more additives that function to enhance ATF resistance.

Each of the layers or components of the magnet wire 170 of FIG. 1D will now be described in greater detail. The example magnet wires 100, 120, 150 of FIGS. 1A-1C may include layers or components similar to those described with reference to FIG. 1D. Indeed, as desired in various embodiments, a magnet wire may be formed with a wide variety of suitable cross-sectional shapes and insulation configurations provided that at least one layer of insulation includes one or more additives that enhance ATF resistance incorporated into a PI base polymeric material.

With reference to FIG. 1D, the conductor 175 may be formed from a wide variety of suitable materials and/or combinations of materials. For example, the conductor 175 may be formed from copper, annealed copper, oxygen-free copper, silver-plated copper, nickel plated copper, tin plated copper, lead plated copper, molybdenum plated copper, tungsten plated copper, copper clad aluminum (“CCA”), a conductive alloy, a material that is coated with copper, any other suitable electrically conductive material that includes copper, aluminum, or any other suitable conductive material or combination of conductive materials. Additionally, the conductor 175 may be formed with any suitable dimensions and/or cross-sectional shapes. As shown, the conductor 175 may have a rectangular cross-sectional shape. In other embodiments, such as those illustrated in FIGS. 1A and 1C, a conductor may have a circular or round cross-sectional shape. In yet other embodiments, a conductor may be formed with a square shape, an elliptical or oval shape, a hexagonal shape, or any other suitable cross-sectional shape. Additionally, as desired for certain cross-sectional shapes such as a hexagonal shape or the illustrated rectangular shape, a conductor may have corners that are rounded, sharp, smoothed, curved, angled, truncated, or otherwise formed. For example, a shaped rectangular wire may have rounded corners.

The conductor 175 may also be formed with any suitable dimensions, such as any suitable gauge, diameter, height, width, cross-sectional area, etc. As one non-limiting example, the longer sides of a rectangular conductor 175 may be between approximately 0.020 inches (508 micrometers “μm”)) and approximately 0.750 inches (19,050 μm), and the shorter sides may be between approximately 0.020 inches (508 μm) and approximately 0.400 inches (10,160 μm). An example square conductor may have sides between approximately 0.020 inches (508 μm) and approximately 0.500 inches (12,700 μm). An example round conductor may have a diameter between approximately 0.010 inches (254 μm) and approximately 0.500 inches (12,700 μm). Other suitable dimensions may be utilized as desired.

A wide variety of suitable methods and/or techniques may be utilized to form, produce, or otherwise provide a conductor 175. In certain embodiments, a conductor 175 may be formed by drawing input material (e.g., a larger conductor, rod stock, etc.) through one or more dies in order to reduce the size of the input material to desired dimensions. As desired, one or more flatteners and/or rollers may be used to modify the cross-sectional shape of the input material before and/or after drawing the input material through any of the dies. In certain embodiments, the conductor 175 may be formed in tandem with the application of a portion or all of the insulation system. In other words, conductor formation and application of insulation material may be conducted in tandem. In other embodiments, a conductor 175 with desired dimensions may be preformed or obtained from an external source, and insulation material may then be applied via a subsequent process.

With continued reference to FIG. 1D, a plurality of insulation layers 180, 185 are depicted as being formed around the conductor 175. In other embodiments, as shown in FIGS. 1A and 1C, a single insulation layer (e.g., a sole coat of PI enamel insulation) is depicted. In the event that a plurality of insulation layers 180, 185 are formed around the conductor, any suitable number of insulation layers may be formed. For example, as shown in FIG. 1D, a first basecoat insulation layer 180 and a second topcoat insulation layer 185 may be formed. As another example, three insulation layers may be formed, such as a basecoat, a midcoat, and a topcoat layer. Other embodiments may include more than three layers.

In embodiments in which the magnet wire 170 has a single insulation layer, a sole coat of a suitable PI material including one or more additives may be provided. In embodiments that include a plurality of insulation layers 180, 185, each insulation layer 180, 185 may be formed from a wide variety of suitable materials. As desired, one or more insulation layers may be formed as enamel layers from thermosetting polymeric materials with at least one layer formed from a PI material including one or more additives. Additionally, it will be appreciated that a given insulation layer may include one or more sublayers. For example, an enamel layer may be formed with any number of sublayers that are successively formed until a desired build thickness is attained.

In certain embodiments in which the magnet wire 170 includes a plurality of insulation layers 180, 185, each of the layers may be formed from the same polymeric material. For example, two separate layers may be formed from a suitable PI material and at least one of the layers (e.g., an outermost or topcoat layer) may include one or more additives to enhance ATF resistance. In other embodiments, at least two of the insulation layers (e.g., layers 180, 185, etc.) may be formed from different materials or materials having different molecular constructions and/or compositions. For example, two enamel layers may be formed from different thermosetting polymeric materials, such as a first layer of PI with additives and a second layer of another thermosetting material (which may optionally include additives, fillers, etc.).

A wide variety of other thermosetting materials may be utilized, such as different PI materials (e.g., different PI copolymers, PI layers formed from different diamine and/or dianhydride components, etc.), or any of the polymeric materials other than PI discussed herein that may be suitable for forming enamel layers. As another example, two enamel layers may be formed from the same base polymeric materials; however, the two enamel layers may include different fillers and/or additives, different filler or additive loading factors, or combinations thereof. A wide variety of suitable fillers and/or additives may be selectively incorporated into any of the insulation layers. Additionally, according to an aspect of the disclosure, additives that enhance ATF resistance may be utilized in conjunction with any number of insulation layers, provided that the insulation layer configured to contact the majority of the ATF directly contains said additives. For example, additives may be utilized in the formation of each of the layers or in a subset of the layers.

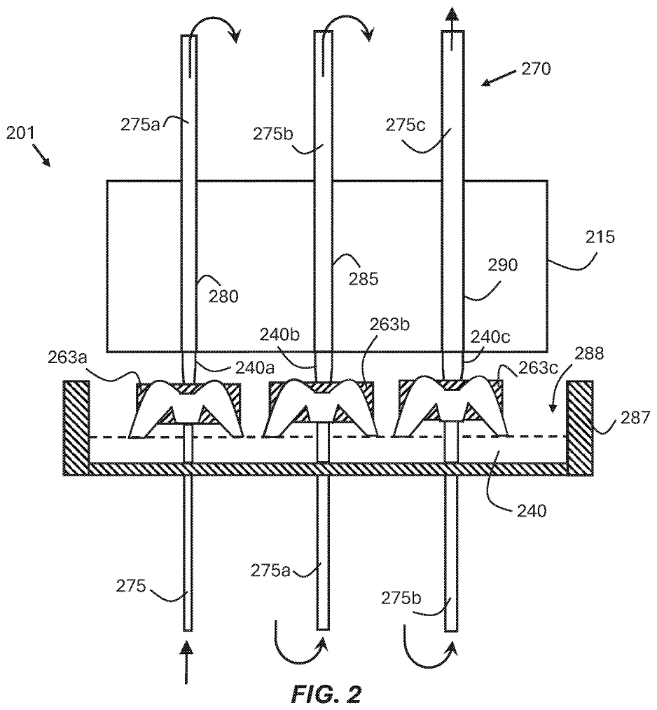

As set forth above, in certain embodiments, a magnet wire 100, 120, 150, 170 may include one or more enamel layers of insulation formed from thermosetting polymeric material with at least one layer formed from a PI material. An enamel layer is typically formed by applying a polymeric varnish to the conductor 105, 125, 155, 175 and then baking the conductor 105, 125, 155, 175 in a suitable enameling oven or furnace (see also, FIG. 2).

FIG. 2 further illustrates an example enamel applicator assembly 201, which can be used to apply all or a portion of the insulation system around the conductor 275. FIG. 2. is a cross-sectional schematic representation of a vertically oriented enamel applicator assembly 201. The enamel applicator assembly 201 applies liquid polymeric varnish 240, 240a, 240b, 240c around a conductor 275 through an applicator 287 and dies 263. The term “liquid polymeric varnish” and “liquid enamel” are used interchangeably throughout. The applied polymeric varnish 240a, 240b, 240c is then cured through a curing oven 215 to form PI and exemplary additive containing enamel insulation layers 280, 285, 290 (see also 110, 130, 135, 160, 180, 185) surrounding the conductor 275. The “curing oven” 215 is sometimes referred to as an “enameling oven” herein.

The conductor 275 is formed prior to entering the enamel applicator assembly 201. In certain exemplary embodiments, the conductor 275 may be formed by drawing input material (e.g., a larger conductor, rod stock, etc.) through one or more dies in order to reduce the size of the input material to desired dimensions. As desired, one or more flatteners and/or rollers may be used to modify the cross-sectional shape of the input material before and/or after drawing the input material through any of the dies. In certain embodiments, the conductor 275 may be formed in tandem with the application of a portion or all of the insulation system. In other words, conductor formation and application of insulation material may be conducted in tandem. In other embodiments, a conductor 275 with desired dimensions may be preformed or obtained from an external source, and insulation material may then be applied via a subsequent process.

In operation and prior to entering the enamel applicator assembly 201, the bare conductor 275 may optionally pass through an upstream annealing oven (not depicted) to thermally process the bare conductor 275 to desired physical properties, such as strength and ductility. Once annealed, the annealed conductor 275 may then pass through an enamel applicator 287 as further described below. In other exemplary embodiments, the upstream annealing step can be absent.

The enamel applicator assembly 201 generally comprises an enamel applicator 287, a curing oven 215 positioned downstream of the enamel applicator 287, and one or more dies 263 positioned between the enamel applicator 287 and the curing oven 215. The enamel applicator 287 defines a reservoir 288 and liquid polymeric varnish 240 240 is contained within this reservoir 288.

This liquid polymeric varnish 240 comprises a polyamic acid or other PI precursor and one or more additives comprising at least one unsaturated C═C-containing compound having one or multiple groups of vinyl, allyl, maleimide, nadimide, and/or itaconimide, such as a bismaleimide (“BMI”), bisnadimide (“BNI”), bismethylnadimide (“BMNI”), methylnadimides (“MNI”), N-arylitaconimides (“NAI”) monomers, and/or bisitaconimide (“BII”), triallyl isocyanurate (“TAIC”), trimethallyl isocyanurate (“TMAIC”); triallyl cyanurate (“TAC”), triallyl trimellitate (“TATM”), tris[2-(acryloyloxy)ethyl]isocyanurate, and/or trimethallyl isocyanurate (“TMAIC”) that are suspended in one or more solvents. The liquid polymeric varnish 240 is preferably prepared in a reactor prior to being introduced into the reservoir 288. There are a variety of methods for producing the exemplary liquid polymeric varnish 240. For example, the additive(s) may be incorporated into a polyamic acid or PI precursor in the presence of solvent(s). One example of a polyamic acid is an acid prepared from pyromellitic dianhydride (“PMDA”) and 4,4′-oxydianiline (“ODA”) in the presence of solvents (e.g., N-methylpyrrolidone or “NMP”, dimethylacetamide or “DMAc”, etc.). Other suitable materials may be utilized as dianhydride and diamine materials in order to form a polyamic acid. Additionally, a wide range of other suitable solvents and/or solvent blends may be utilized. The exemplary additives are preferably added prior to the liquid polymeric varnish 240 being introduced to the reservoir 288.

In an exemplary embodiment, the liquid polymeric varnish 240 is a homogeneous mixture. The organic unsaturated C═C-containing compound particles (i.e., the ATF-resistant additive(s)) can be evenly distributed into the liquid polymeric varnish mixture 240 by continuous stirring, liquid enamel agitation, or other mixing technique. As the conductor 275 first passes through the applicator 287, the conductor 275 draws up some of the liquid polymeric varnish 240 into and through a first die 263a. As the conductor 275 continues through the first die 263a, the first die 263a draws off excess liquid polymeric varnish 240 to ensure uniform application of the liquid polymeric varnish 240 around the conductor 275. For the purposes of this disclosure, the layer of liquid polymeric varnish that remains on the conductor 275 after the conductor 275 passes through the first die 263a is known as a “first applied layer of polymeric varnish” 240a. The wet coated conductor 275 (i.e., the conductor 275 having the first applied layer of polymeric varnish 240a) then passes through the curing oven 215. In certain embodiments, the PI layer may be cured at a temperature greater than 250 °C. The curing oven 215 evaporates or otherwise removes the solvent from the first applied layer of polymeric varnish 240a and applies heat to thereby cure the first applied layer of polymeric varnish 240a into a first layer or sublayer 280 of enamel insulation, wherein the first layer or sublayer 280 of insulation comprises the solid PI and an exemplary organic unsaturated C═C-containing compound disposed around the conductor 275.

The conductor having undergone a first cure (i.e., “first cured conductor 275a”) can then be passed through the applicator 287 and curing oven 215 several more times via pulleys (not depicted) ancillary to the enamel applicator assembly 201. With successive passes, liquid polymeric varnish 240 continues to be applied via the applicator 287, evenly distributed around the last layer of insulation through dies 263b, 263c, etc. and cured in the curing oven 215 to thereby progressively build the thickness of one or more insulation layers 280, 285, 290 to a desired thickness. In this manner, a first layer 280, a second layer 285, or additional layers 290 of insulation comprising solid PI and an unsaturated C═C-containing compound can be successively formed around the conductor 275.

That is in the exemplary depiction of FIG. 2, the first cured conductor 275a is then wrapped around a pair or pulleys and is directed back into the applicator 287. As the first cured conductor 275a moves through the reservoir 288 of liquid polymeric varnish 240, the first cured conductor 275a draws up some of the liquid polymeric varnish 240 into a second die 263b. The second die 263b draws off excess liquid polymeric varnish 240 to ensure uniform application of the liquid polymeric varnish 240 around the first cured conductor 275a. For the purposes of this disclosure, the layer of liquid polymeric varnish that remains on the first cured conductor 275a after the first cured conductor 275a passes through the second die 263b is known as a “second applied layer of polymeric varnish” 240b. The wet coated conductor 275a (i.e., the first cured conductor 275a having the second applied layer of polymeric varnish 240b) then passes through the curing oven 215 to define a second cured conductor 275b. That is, the curing oven 215 evaporates or otherwise removes the solvent from the second applied layer of polymeric varnish 240b and applies heat to thereby cure the second applied layer of polymeric varnish 240b into a second layer or sublayer 285 of insulation, wherein the second layer or sublayer 285 of insulation comprises the solid PI and an exemplary organic unsaturated C═C-containing compound disposed around (or surrounding) the conductor 275.

Continuing with the exemplary depiction in FIG. 2, the second cured conductor 275b is then wrapped around a pair or pulleys and is directed back into the applicator 287. As the second cured conductor 275b moves through the reservoir 288 of liquid polymeric varnish 240, the second cured conductor 275b draws up some of the liquid polymeric varnish 240 into a third die 263c. The third die 263c draws off excess liquid polymeric varnish 240 to ensure uniform application of the liquid polymeric varnish 240 around the second cured conductor 275b. For the purposes of this disclosure, the layer of liquid polymeric varnish that remains on the second cured conductor 275b after the second cured conductor 275b passes through the third die 263c is known as a “third applied layer of polymeric varnish” 240c. The wet coated conductor 275b (i.e., the second cured conductor 275b having the third applied layer of polymeric varnish 240c) then passes through the curing oven 215. The curing oven 215 evaporates or otherwise removes the solvent from the third applied layer of polymeric varnish 240c and applies heat to thereby cure the third applied layer of polymeric varnish 240c into a third layer or sublayer 290 of insulation, wherein the third layer or sublayer 290 of insulation comprises the solid PI and an exemplary organic unsaturated C═C— containing compound disposed around (or surrounding) the conductor 275.

It will be appreciated that enamel applicator assemblies 201 can be configured to have additional capacity to allow for additional passes of the wire 270 through the enamel applicator assemble to thereby create additional insulation layers or sublayers with exemplary additives around the wire 270. After exiting the enamel applicator assembly 201, the wire 270 may undergo additional example processing steps, such as additional enameling, annealing, quality control, cooling, and winding or packaging for storage or distribution.

It will be appreciated that the specific arrangement of the assembly components can be modified or re-oriented as desired for a particular application. For example, although a vertical applicator 287 and curing oven 215 are depicted, a horizontal assembly is also within the scope of this disclosure.

The polymeric varnish 240 typically includes polymeric solids material suspended in one or more solvents, wherein the polymeric solids may be thermosetting and/or thermoplastic and/or their compositions with fillers and additives. Following application of the varnish (on the conductor or an underlying insulation layer), solvent is removed by evaporation, heat, and/or radiation, thereby leaving a solid polymeric enamel layer containing the solid thermosetting polymer (e.g., PI) and an exemplary additive comprising an unsaturated C═C-containing compound as described herein. In exemplary embodiments comprising PI, it is contemplated that in certain exemplary embodiments, one or more enamel insulation layers 280, 285, 290 may contain an exemplary unsaturated C═C-containing compound additive (i.e., “ATF-resistant additive”) in a range of about 0.3% to about 40% relative to the weight of the solid polyimide in a given length of sample taken from a production run. Typical sample lengths range from about 0.5 meter to about 1 meter.

The composition of the insulation layers can be verified by methods known in the art, including preferably by non-destructive techniques such as absorption spectroscopy techniques. Useful absorption spectroscopy techniques include Fourier-transform infrared spectroscopy (“FTIR”), Raman spectroscopy, nuclear magnetic resonance (“NMR”) spectroscopy, and the like, with FTIR being most common.

As desired, multiple sublayers of enamel may be applied to the conductor 105, 125, 155, 175, 275 to form an enamel insulation layer 280, 285, 290. For example, a first sublayer of 240 enamel may be applied, and the conductor 105, 125, 155, 175, 275 may be passed through an enameling oven 215 or other suitable curing and/or solidifying device. Examples of suitable curing and/or solidifying devices include, but are not necessarily limited to: infrared light, induction, ultraviolet light, and electron beam, including but not limited to microwave radiation. A second sublayer of enamel 240 may then be applied, and the conductor 105, 125, 155, 175, 275 may make another pass through the curing device (or a separate curing device). This process may be repeated until a desired number of enamel coats have been applied and/or until a desired enamel thickness or build has been achieved. As desired, an enameling oven 215 may be configured to accommodate a wire 100, 120, 150, 170 making multiple passes through the curing oven 215.

Other curing devices that may be utilized in addition to or as an alternative to enameling ovens 215 include, but are not limited to, infrared light systems, ultraviolet light systems, and/or electron beam systems. Any number of enamel layers may be formed in various embodiments. Additionally, each layer of enamel and/or a total enamel build may have any desired thickness, such as a thickness of approximately 0.0002 inches (5.08 μm), 0.0005 inches (12.7 μm), 0.007 inches (177.8 μm), 0.001 inches (25.4 μm), 0.002 inches (50.8 μm), 0.003 inches (76.2 μm), 0.004 inches (101.6 μm), 0.005 inches (127 μm), 0.006 inches (152.4 μm), 0.007 inches (177.8 m), 0.008 inches (203.2 μm), 0.009 inches (228.6 μm), 0.010 inches (254 μm), 0.012 inches (304.8 μm), 0.015 inches (381 μm), 0.017 inches (431.8 μm), or 0.020 inches (508 μm), a thickness included in a range between any two of the aforementioned values, or a thickness included in a range bounded on either a minimum or maximum end by one of the aforementioned values.

Although PI is preferred, a wide variety of different types of polymeric materials may be utilized as desired to form an enamel layer 110, 130, 135, 160, 180, 185, 280, 285, 290. Examples of suitable materials include, but are not limited to, polyimide (“PI”), polyamideimide (“PAI”), amideimide, polyurethane, polyester, THEIC polyester, polyesterimide, polyester amide imide, polysulfone, polyphenylenesulfone, polysulfide, polyphenylenesulfide, polyetherimide, polyamide, polyamide-ester-imide, polyimidesulfones, polybenzimidazole (“PBI”), poly(oxyphenylene benzimidazole) (“OPBI”), poly(benzimidazole-imide) (“PBII”), polybenzimidzopyrrolone (“PBIP”), polyketones, a phenolics polymer, an epoxide polymer, silicone-containing polyimide, a silicone polymer, fluoride-containing polyimide, a fluorinated polymer, and the like, including derivations, combinations, mixtures, blends, and composites of the foregoing.

According to an aspect of the disclosure, at least one layer may be formed from PI including one or more additives to enhance ATF resistance. As desired, a wide variety of commonly used additives (other than the additives described herein to enhance ATF resistance) may be combined with a polymeric material used to form an enamel layer. Examples of such additives include crosslinkers, curing promoters (e.g., catalysts for chemical reactions), heat stabilizers (e.g., metallic salts, organometallic compounds, organic phosphites, antioxidants, hindered phenols, tertiary amines), antioxidants (e.g., radical scavengers, chain terminating primary antioxidants such as hindered phenols and aromatic amines, hydroperoxide decomposing secondary antioxidants such as phosphites and thioesters, etc.), UV stabilizers (e.g. benzotriazoles, benzophenones, and organic nickel compounds, hindered amine light stabilizers (HALS), phenolic antioxidants, phosphite antioxidants, thioesters, aminic antioxidants), plasticizers (e.g., phthalates, benzoate and dibenzoate esters, phosphates, adipates, citrate esters, alkyl sulfonic acid esters, polyol-carboxylic acid esters, epoxidized soybean oil (ESBO), epoxidized linseed oil (ELO), castor oil, palm oil, starches, isosorbide esters, chlorinated paraffin, etc.), antistatic agents (e.g., potassium or sodium phosphate acid ester salts, quaternary amines, nonionic surfactants of ethylene oxide and/or propylene oxide, etc.), antiblocking agents (e.g., paraffinic wax, compounds of ethylene oxide (EO) and/or propylene oxide (PO), fatty acid soaps, fatty acid amide, silicones, silicates, etc.), blowing agents (e.g., hydrocarbons, hydrazine and other decomposed nitrogen compounds such as dinitrosopenta methylene tetraamine (DNPT), azodicarbonamide (ADC), and sodium bicarbonate, ammonium carbonate, etc.), lubricants (e.g., metallic stearate, boron nitride, paraffin waxes, cetyl palmitate and cetyl sebacate, fatty acid amides and esters, fluoropolymers, silicones, etc.), process modifiers, and/or processing aids, rheological modifiers (e.g., thinners, thickeners, etc.), defoaming agents (e.g., silicone type, fluorine type, or polymer type defoaming agents, etc.), leveling agents to reduce surface tension, compatibilizers (e.g., block copolymers, etc.), coupling or surface-treatment agents (e.g., organic silanes, titanates, zirconates, anhydrides), impact modifiers (e.g., elastomeric compounds, etc.), adhesion promoters (e.g., organic silanes, titanates, zirconates), flame retardants (e.g., phosphorus type flame retardants, nitrogen type flame retardants, metal salt flame retardants, etc.), reinforcement modifiers (e.g., fibers, fillers, minerals, etc.), inorganic non-metallic fillers in spheres, fibers or irregular shapes, organic fillers, pigments, dyes, and/or colorants (e.g., phthalocyanine blue, phthalocyanine green, iodine green, disazo yellow, crystal violet, titanium oxide, carbon black, naphthalene black, etc.), antimicrobial agents (e.g., quaternary ammonium salts, silver compounds, etc.), deodorants, and/or water absorbents (e.g., epoxy compounds, etc.).

Example crosslinkers include, but are not limited to, isocyanate compound, blocked isocyanate compound, cyanate ester compound, aziridine compound, acid anhydride group-containing compound, carboxyl group-containing compound, carbodiimide group-containing compound, benzoxazine compound, vinyl ether compound, vinyl benzyl ether resin, thiol compound, melamine compound, guanamine compound, amino resin, phenol resin, alkyd resin, acrylic resin, unsaturated polyester resin, silicone resin, xylene resin, furan resin, ketone resin, dicyclopentadiene resin and thermosetting resin obtained by trimerization of an aromatic dicyanamide.

Example curing promoters include, but are not limited to, imidazole derivatives, guanamines (e.g., acetoguanamine, benzoguanamine, etc.), polyamines (e.g., diaminodiphenylmethane, m-phenylenediamine, m-xylenediamine, diaminodiphenylsulfone, dicyandiamide, urea, urea derivatives, melamine, polybasic hydrazide, etc.), organic acid salts and/or epoxy adducts thereof, amine complex of boron trifluoride, triazine derivatives (e.g., ethyldiamino-s-triazine, 2,4-diamino-s-triazine, 2,4-diamino-6-xylyl-s-triazine, etc.), tertiary amines (e.g., trimethylamine, triethanolamine, N,N-dimethyloctylamine, N-benzyldimethylamine, pyridine, N-methylmorpholine, hexa(N-methyl)melamine, 2,4,6-tris(dimethylaminophenol), tetramethylguanidine, 1,8-diazabicyclo[5,4,0]-7-undecene (“DBU”), 1,5-diazabicyclo[4,3,0]-5-nonene (“DBN”), etc.), organic acid salts and/or tetraphenyl boroates thereof, polyvinylphenol, polyvinylphenol bromide, organic phosphines (e.g., tributyl phosphine, triphenyl phosphine, tris-2-cyanoethyl phosphine, etc.), and quaternary phosphonium salts (e.g., tri-n-butyl (2,5-dihydroxyphenyl)phosphonium bromide, hexadecyltributyl phosphonium, etc.).

In certain embodiments, one or more other filler materials may be incorporated into an enamel layer as desired. Examples of suitable filler materials include, but are not limited to, inorganic materials such as metals, transition metals, lanthanides, actinides, carbon nanotubes, boron nitride, metal oxides, and/or hydrated oxides of suitable materials such as aluminum, tin, boron, germanium, gallium, lead, silicon, titanium, chromium, zinc, yttrium, vanadium, zirconium, nickel, etc. (e.g., titanium dioxide, silica or silicon dioxide, etc.); suitable organic materials such as polyaniline, polyacetylene, polyphenylene, polypyrrole, other electrically conductive particles; and/or any suitable combination of materials (e.g., a mixture or blend of metal oxides, etc.). In certain embodiments, the filler material(s) may enhance corona resistance and/or one or more thermal properties (e.g., temperature resistance, cut-through resistance, abrasion resistance, heat shock, etc.). The particles of a filler material may have any suitable dimensions, and any suitable blending ratio or fill rate between filler material and polymeric materials may be utilized (e.g., a fill rate of approximately 5, 10, 15, 20, 25, 30, 35, or 40 percent, or a fill rate included in a range between any of these values). Additionally, if a filler includes a blend of different materials, any suitable blending ratio may be utilized between the components of the filler.

The insulation materials incorporated into a magnet wire 170 may be selected in order to achieve a wide variety of suitable properties and/or characteristics. For example, polymeric materials and/or various combinations of polymeric materials may be selected in order to achieve a desired thermal classification (or thermal class), thermal index, and/or thermal endurance. Thermal classes, which are generally established by industry standards organizations (e.g., the National Electric Manufacturers Association, the International Electrotechnical Commission, UL, etc.), establish maximum allowable temperatures for an insulation material and/or magnet wire. Example thermal classes include, for example, 150 °C, 180 °C, 200 °C, 220 °C, 240 °C, 250 °C, 260 °C, 270 °C, and 280 °C. A thermal index is generally defined as a number in degrees Celsius that compares the temperature vs. time characteristics of an electrical insulation material. It may be obtained by extrapolating the Arrhenius plot of life versus temperature to a specified time, usually 20,000 hours. As an example of the difference between a thermal class and a thermal index, a material may have a thermal index of 230 °C; however, that material will have a thermal class of 220 °C as it does not meet the requirements of the next available thermal class of 240 °C. As another example, polymeric materials may be selected based upon their physical properties (e.g., whether a thermoplastic material is amorphous, crystalline, semi-crystalline, etc.), shrinkage characteristics, resistance to certain fluids (e.g., automatic transmission fluid), partial discharge inception voltage, dielectric strength, and/or any other suitable characteristics.

In certain embodiments, an insulation system formed on a magnet wire 170 may have a wide variety of suitable electrical performance parameters, such as a wide variety of suitable PDIV values and/or dielectric strength or breakdown strength values. In certain embodiments, an insulation system may provide a PDIV value at 25 °C of at least approximately 800, 900, 1000, 1100, 1200, 1250, 1300, 1350, 1400, 1450, 1500, 1550, 1600, 1700, 1800, 1900, 2000, 2100, 2200, 2300, or 2400 volts, or a PDIV value included in a range between any two of the above values. Similarly, in certain embodiments, an insulation system may provide a dielectric strength value (e.g., a dielectric strength value measured by a suitable industry standard test such as a shotbox or foil test, etc.) of at least approximately, 10,000, 11,000, 12,000, 12,500, 13,000, 13,500, 14,000, 14,500, 15,000, 15,500, 16,000, 16,500, 17000, 17,500, 18,000, 18.500, 19,000, 20,000, 20,500, or 21,000 volts, or a dielectric strength value included in a range between any two of the above values. Other suitable performance parameters may be targeted and/or achieved as desired. As described in greater detail below the PDIV values and/or the dielectric strength values of an insulation system may be enhanced as a result of forming insulation layers utilizing one or more additives that lower permittivity.

Additionally, in embodiments that incorporate a plurality of insulation layers, any suitable ratio or ratios of thicknesses may be utilized between the various layers. Using an example of an insulation system having two insulating layers, the first layer may constitute any suitable percentage (e.g., 1-99%, at least 50%, etc.) of the overall thickness of the combined insulation, and the second layer may constitute any suitable percentage of the overall thickness. As desired, thickness ratios of insulating layers may be selected in order to satisfy a wide variety of suitable design parameters. For example, desired electrical performance may be balanced against the cost of materials utilized to form the insulation layers.

Regardless of the insulation system formed on a magnet wire, according to an aspect of the disclosure, one or more additives that enhance ATF resistance may be utilized in the formation of and/or incorporated into any desired number of insulation layers including at least one PI layer. For example, one or more additives may be utilized in the formation of a single insulation layer (e.g., layer 180, layer 185, etc.). As other examples, one or more additives may be utilized in the formation of a plurality of insulation layers 180, 185, a subset of insulation layers, or all of the insulation layers.

As desired in various embodiments, a wide variety of different additives and/or combinations of additives may be utilized to enhance ATF resistance. According to an aspect of the disclosure, the additives utilized to enhance ATF resistance may include one or more unsaturated C═C-containing chemical compounds in molecules. In other words, one or more additives may include compounds having at least one double bond (C═C) between carbon atoms while the carbon atoms in the double bond are not bonded to the maximum number of hydrogen atoms. As desired in various embodiments, an unsaturated C═C-containing compound utilized as an additive may have a boiling point above approximately 150 °C at ambient conditions.

In certain embodiments, the additives may include one or more compounds having one or multiple groups of vinyl, allyl, maleimide, nadimide, and/or itaconimide. For example, one or more allyls (as defined above) may be utilized as additives. In other embodiments, the additives may include one or more bismaleimides (“BMI”), bisnadimides (“BNI”), methylnadimides (“MNI”), bismethylnadimides (“BMNI”), N-arylitaconimides (“NAI”) monomers, and/or bisitaconimide (“BII”) materials.

A few non-limiting examples of suitable additives include, but are not limited to, triallyl isocyanurate (“TAIC”) (CAS No. 1025-15-6); trimethallyl isocyanurate (“TMAIC”); triallyl cyanurate (“TAC”); triallyl trimellitate (“TATM”); tris[2-(acryloyloxy)ethyl]isocyanurate; trimethallyl isocyanurate (“TMAIC”); 2,2′-diallyl-bisphenol A (CAS No. 1745-89-7); N-cyclohexyl maleimide; N-vinyl maleimide; N-ally maleimide; N-phenyl maleimide; N-biphenyl maleimide; N-benzophonone maleimide, N-(4-vinylphenyl)maleimide; N-(p-methylphenyl) maleimide; N-benzyl maleimide; other suitable N-aromatic maleimides known to those skilled in the art.

Examples of suitable allyls include, but are not limited to triallyl isocyanurate (“TAIC”) (CAS No. 1025-15-6); trimethallyl isocyanurate (“TMAIC”); triallyl cyanurate (“TAC”); triallyl trimellitate (“TATM”); tris[2-(acryloyloxy)ethyl]isocyanurate; trimethallyl isocyanurate (“TMAIC”), etc. TAIC and TMAIC have been found to be particularly useful additives. Without being bound by theory, it is contemplated that these particular allyl cyanurates act as crosslinkers that can contribute to the creation of a semi-interpenetrating (“Semi-IPN”) in the PI insulation layer to thereby improve ATF resistance.

Examples of suitable bismaleimides (“BMI”) include: diphenylmethane bismaleimide (“BMIM”); diphenylsulfone bismaleimide (“DDS/BMI”); phenylene bismaleimide (“PDA/BMI”); bis(aminophenoxyphenyl)propane bismaleimide (“BAPP/BMI”), oxydianiline bismaleimide (“ODA/BMI”); bismaleimidodimethylbiphenyl (“TLD/BMI”); 1,1′-(3,3′-dimethoxyl-1,1′-biphenyl-4,4′-diyl)bismaleimide (“DAS/BMI”); bis(aminophenoxy)benzene bismaleimide (“APB/BMI”); bis(maleimidophenoxy) biphenyl (“BABP/BMI”); diaminodiphenyldetone bismaleimide (“DABP/BMI”); diaminodiphenyl sulfide bismaleimide; bis(maleimido) biphenyl; bis(diaminodiphenylisopropylidimine)benzene bismaleimide; and other suitable bismaleimides having high thermal resistance known to those skilled in the art. Phenylene bismaleimide, diphenylsulfone bismaleimide, bis(maleimidophenoxy)biphenyl, bis(maleimido)biphenyl, bismaleimidodimethylbiphenyl, and diphenylmethane bismaleimide have been found to be particularly useful additives.

Examples of suitable bisnadimides (“BNI”) include: N-cyclohexyl nadimide; N-vinyl nadimide; N-ally nadimide; N-phenyl nadimide; N-biphenyl nadimide; N-benzophonone nadimide, N-(4-vinylphenyl) nadimide; N-(p-methylphenyl) nadimide; N-benzyl nadimide; other suitable N-aromatic nadimides; N,N′-(1,4-phenylene)dinadimide (“PPD/BNI”), 4,4′-bisnadimido-2,2′-dimethylbiphenyl (“MTLD/BNI”), 4,4′-bis(4-nadimidophenyl)ether (“ODA/BNI”), 4,4′-bis(4-nadimidophenyl)ether (“ODA/BNI”); diphenylmethane bisnadimide (“BMIN”); diphenylsulfone bisnadimide (“DDS/BNI”); phenylene bisnadimide (“PDA/BNI”); bis(aminophenoxyphenyl)propane bisnadimide (“BAPP/BNI”); oxydianiline bisnadimide (“ODA/BNI”); bisnadimidodimethylbiphenyl (“TLD/BNI”); 1,1′-(3,3′-dimethoxyl-1,1′-biphenyl-4,4′-diyl)bisnadimide (“DAS/BNI”); bis(aminophenoxy)benzene bisnadiimide (“APB/BNI”); bis(nadimidophenoxy) biphenyl (“BABP/BNI”); diaminodiphenyldetone bisnadimide (“DABP/BNI”); diaminodiphenyl sulfide bisnadimide; bis(nadimideo) biphenyl; bis(diaminodiphenylisopropylidimine)benzene bisnadimide; N,N′-(1,4-phenylene)dinadimide (“PPD/BNI”); 4,4′-bisnadimido-2,2′-dimethylbiphenyl (“MTLD/BNI”); 4,4′-bis(4-nadimidophenyl)ether (“ODA/BNI”); 4,4′-bis(4-nadimidophenyl)ether (“ODA/BNI”); and other suitable bisnadimides having high thermal resistance known to those skilled in the art. N,N′-(1,4-phenylene)dinadiimide (“PPD/BNI”), 4,4′-bisnadiimido-2,2′-dimethylbiphenyl (“MTLD/BNI”), 4,4′-bis(4-nadiimidophenyl)ether (“ODA/BNI”), 4,4′-bis(4-nadiimidophenyl)ether (“ODA/BNI”) have been found to be particularly useful additives.

Examples of suitable N-arylitaconimide (“NAI”) monomers include: N-phenylitaconimide; N-(4-methoxyphenyl)itaconimide, and other suitable N-arylitaconimides known to those having ordinary skill in the art.

Examples of suitable methylnadimides (“MN”) include: N-cyclohexyl methylnadiimide; N-vinyl methylnadiimide; N-ally methylnadiimide; N-phenyl methylnadiimide; N-biphenyl methylnadiimide; N-benzophonone methylnadiimide, N-(4-vinylphenyl) methylnadiimide; N-(p-methylphenyl) methylnadiimide; N-benzyl methylnadiimide; other suitable N-aromatic methylnadiimides known to those skilled in the art.

Examples of suitable bismethylnadimides (“BMNI”) include: diphenylmethane bismethylnadimide (“BMIMN”); diphenylsulfone bismethylnadimide (“DDS/BMNI”); phenylene bismethylnadimide (“PDA/BMNI”); bis(aminophenoxyphenyl)propane bismethylnadimide (“BAPP/BMNI”); oxydianiline bismethylnaimide (“ODA/BMNI”); bismethylnadimidodimethylbiphenyl (“TLD/BMNI”); 1,1′-(3,3′-dimethoxyl-1,1′-biphenyl-4,4′-diyl)bismethylnadimide (“DAS/BMNI”); bis(aminophenoxy)benzene bismethylnadimide (“APB/BMNI”); bis(methylnadimidophenoxy) biphenyl (“BABP/BMNI”); diaminodiphenyldetone bismethylnadimide (“DABP/BMNI”); diaminodiphenyl sulfide bismethylnadimide; bis(methylnadimideo) biphenyl; bis(diaminodiphenylisopropylidimine)benzene bismethylnadimide; other suitable bismethyl. Nadiimides known to those skilled in the art.

Examples of suitable bisitaconimides (“BII”) include: diphenylmethane bisitaconimide (“BMII”); diphenylsulfone bisitaconimide (“DDS/BII”); phenylene bisitaconimide (“PDA/BII”); bis(aminophenoxyphenyl)propane bisitaconimide (“BAPP/BII”); oxydianiline bisitaconimide (“ODA/BII”); bisitaconimidodimethylbiphenyl (“TLD/BII”); 1,1′-(3,3′-dimethoxyl-1,1′-biphenyl-4,4′-diyl)bisitaconimide (“DAS/BII”); bis(aminophenoxy)benzene bisitaconimide (“APB/BII”); bis(itaconimidophenoxy) biphenyl (“BABP/BII”); diaminodiphenyldetone bisitaconimide (“DABP/BII”); diaminodiphenyl sulfide bisitaconimide; bis(itaconimido) biphenyl; and bis(diaminodiphenylisopropylidimine)benzene bisitaconimide. A wide variety of other suitable additives may be utilized in addition to those set forth above as non-limiting examples.

Without being bound by theory, it is contemplated that bismaleimides may react more quickly with PI polymer chains compared to PI polymer chains that lack ATF-resistant additives. In addition, bismaleimides may be more compatible with PI compared to inorganic additives and organic additives that lack imide groups in their molecular structures, by virtue of the bismaleimides better dispersion and interactions into and with the PI polymer chains. For example, the C═C bond in the bismaleimides may react with the amino (—NH₂) group at the end of the PI polymer chain by an ene-addition reaction (i.e., an Alder-ene reaction). This may contribute to a desirable level of cross-linking between PI polymer chains, which may shield the PI against ATF thermal stabilizer additives, while also permitting a desirable degree of bendability in the PI insulation layer (and by extension, in the entire magnet wire construction). “Cross-linking” may increase the compositions' amorphic nature and decrease crystallinity, thereby increasing the free volume of the polymer enamel insulation layer (i.e., the unoccupied space in enamel insulation layer that is not taken up by molecules). The inventor has discovered that excessive cross-linking within the PI insulation layer can create poor resistance against external physical force (such as bending), which may in turn contribute to cracking and accelerated PI layer breakdown in the presence of ATF. Without being bound by theory, it is contemplated that the exemplary additives disclosed herein may permit some cross-linking among the PI intermolecular chains, but generally less than 10% of the available cross-linking reaction sites. This desirable level of cross-linking may help shield the PI from degrading ATF additives while further permitting the PI insulation layers to remain flexible for magnet wire winding applications. Excessive cross-linking may embrittle the PI insulation layer(s).

In certain embodiments, a single additive for enhancing ATF resistance may be utilized. In other embodiments, a combination of additives or a mixture or blend of multiple additives may be utilized. If a combination of additives is incorporated, any suitable blending ratio of additives may be utilized. Further, one or more additives may be selected based upon a wide variety of suitable characteristics as desired in various embodiments. If a combination of additives is incorporated, any suitable blending ratio of additives may be utilized. For example, each additive may constitute approximately 0.3, 0.5, 1, 5, 10, 15, 20, 25, 30, 40, 50, 60, 70, 75, 80, 90, 95, or 95% of an additive blend, or a percentage included in a range between any two of the above values.

Additionally, any suitable loading factors of additives may be utilized as desired. In other words, any suitable weight percentage of additives may be incorporated into a PI material used to form an insulation layer. In certain embodiments, an additive (or a combination of additives) may constitute between approximately 0.3 percent (0.3%) and approximately forty percent (40.0%) by weight of a formed insulation layer. In other embodiments, an additive (or a combination of additives) may constitute between approximately 0.5 percent (0.5%) and approximately twenty percent (20.0%) by weight of an insulation layer. In various embodiments, the additive(s) may constitute approximately 0.3, 0.5, 1.0, 3.0, 5.0, 7.0, 10.0, 15.0, 20.0, 25.0, 30.0 or 35.0 percent by weight of an insulation layer, a weight percentage included in a range between any two of the above values, or a weight percentage included in a range bounded on the maximum end by one of the above values. Additionally, different loading factors may be utilized in conjunction with different types of additives. For example, an allyl additive may be used with a preferred loading factor between approximately 0.3% and approximately 30.0% while a bismaleimide additive may be used with a preferred loading factor between approximately 0.3% and approximately 10.0%. It will be appreciated that other suitable loading factors may be used as desired.

A wide variety of suitable methods or techniques may be utilized as desired to incorporate one or more additives into an insulation material in order to enhance ATF resistance of an insulation layer. For an enamel insulation layer (e.g., a PI layer, etc.), one or more additives may be mixed or blended into a varnish or solvent-containing solution that further includes polymeric solids material. For example, the additive(s) may be incorporated into a polyamic acid or PI precursor in the presence of solvent(s). One example of a polyamic acid is an acid prepared from pyromellitic dianhydride (“PMDA”) and 4,4′-oxydianiline (“ODA”) in the presence of solvents (e.g., N-methylpyrrolidone or “NMP”, dimethylacetamide or “DMAc”, etc.). Enamel with polyamic acid and solvents quickly reacts into polyimide when heated and cured on a conductor (e.g., copper wire) once applied to the annealed wire and further in the curing oven by the well-known imidization reactions. Other suitable materials may be utilized as dianhydride and diamine materials in order to form a polyamic acid. In operation, one or more additives may be mixed, blended, or otherwise incorporated into a suitable PI-containing varnish that is utilized to form a magnet wire insulation layer. Additionally, a wide range of other suitable solvents and/or solvent blends may be utilized. The varnish may then be applied onto a magnet wire 170 and subsequently cured in order to evaporate the solvent and form a solid polymeric PI layer containing the additive(s). In certain embodiments, the PI layer may be cured at a temperature greater than 250 °C.

Similarly, one or more additives may be mixed or blended into a paste that is either applied to a magnet wire 170 in a relatively low solvent form and cured or that is subsequently dissolved in a higher solvent-containing solution that may be applied onto a magnet wire and cured. Regardless of how the additive(s) are incorporated into a varnish or paste, the additive(s) may be dispersed within the varnish when it is applied to a magnet wire. When the varnish is cured following application on a magnet wire, the solvent may be evaporated to form a solid enamel layer.

As a result of incorporating one or more additives into the PI insulation layers (and/or other insulation layers), the magnet wire and its insulation system may have enhanced resistance to ATF. In certain embodiments, the additive(s) may provide enhanced resistance to one or more antioxidants incorporated into ATF, such as OCA-amine. All ATF is considered to be within the scope of this disclosure, and especially ATFs comprising amines, other weak alkalines, or combinations thereof. Without being bound by theory, it is contemplated that certain ATF thermal stabilizers, particularly mildly basic TEPA-based additives can accelerate the hydrolysis of PI in the presence of water at elevated temperatures. When a PI insulation layer is formed around a magnet wire conductor in any of the manner described above, it is contemplated that not all of the carboxyl (—COOH) functional groups in the polyamic acid precursor are fully imidized into polyimide. These residual carboxyl (—COOH) groups may react with (e.g., draw in or absorb or complex-formation) the tetraethylenepentamine (“TEPA”)-based molecules of the ATF into the PI insulation layer of the magnet wire, which can enhance or accelerate the catalysis of polyimide hydrolysis, which in turn is endemic to the rapid decomposition of the PI insulating layer. So, PI with a higher amount of carboxyl (—COOH) groups in the PI insulator layer may contribute to accelerated breakdown of PI insulation of magnet wire when such magnet wire is dispose in ATF containing such thermal stabilizers.

While providing the PI enamel further time to cure may reduce the amount of unreacted carboxyl (—COOH) groups in a PI insulation layer, it will be appreciated additional cure time will not eliminate the presence of unreacted carboxyl (—COOH) groups completely, and any existence of additional cure time will likely reduce overall production output. Accordingly, Applicant has discovered that adding at least one unsaturated C═C-containing compound, (e.g., a BMI, a BNI, a BMNI, a BII, a TAIC a TMAIC, a TAC, a TATM, or a TMAIC) to the polyamic acid or other PI precursor improves crosslinking of the PI intermolecular chains. Considering the molecular structures of the additives and their chemical properties and interactions with the PI incorporated in, the inventor found that the addition of at least one unsaturated C═C— containing compound, (e.g., a BMI, a BNI, a BMNI, a BII, a TAIC a TMAIC, a TAC, a TATM, or a TMAIC) to the polymeric acid or other PI precursor resulted in a light cross-linking level between molecular PI chains. Whereas crosslinking that is too high is thought to result in high internal layer stress and poor layer resistance to external forces (such as bending of the enameled wire in windings, coils, etc.) the light cross linking could contribute to protecting the PI layer from ATF additives while improving PI layer flexibility. This could improve PI flexibility in PI by forming some crosslinking and/or a semi-interpenetrating (“Semi-IPN”), which could thereby improve PI stability against ATF-led decomposition.

As a result, the PI insulation may exhibit reduced hydrothermal decomposition, breakdown in the PI polymer chain, and/or breakdown of the polymer network formed by the combination of the PI and the additive(s). Further, cracking and/or degradation of the PI insulation as a result of exposure to ATF may be reduced, limited, or prevented relative to PI insulation that does not incorporate the additive(s).

The magnet wires 100, 120, 150, 170, 270 described above with reference to FIGS. 1A-1D and the enameling assembly described above with reference to FIG. 2 are provided by way of example only. A wide variety of alternatives could be made to the illustrated magnet wires 100, 120, 150, 170, 270 as desired in various embodiments. For example, a different number of insulation layers may be utilized than those that are illustrated. As another example, the cross-sectional shape of a magnet wire and/or one or more insulation layers may be altered. Indeed, the present disclosure envisions a wide variety of suitable magnet wire constructions.

### EXAMPLES

The following examples are intended as illustrative and non-limiting, and represent specific embodiments of the present invention. Wire samples having PI enamel insulation including different fillers to enhance ATF resistance were prepared and examined. A PI varnish was formulated by reacting 4,4′-oxydianiline (“ODA”) and pyromellitic dianhydride (“PMDA”) in N-methylpyrrolidone (“NMP”) and/or N—N-dimethylacetamide (“DMAc”) solvents. Various additives were then added to PI varnish samples for evaluation as indicated in Table 1. Once formulated, magnet wire samples were formed by applying the enamel varnishes to conductors and curing the wire samples. Both control samples and samples with different additives were formed. Unless otherwise stated, the enamel wire samples discussed in the examples were prepared as 18 American Wire Gauge (“AWG”) (0.823 mm²) wire with a “heavy” enamel build. In other words, the wire enamels were applied to an 18 AWG (0.823 mm²) copper wire using multi-pass coating and wiping dies. The “heavy” enamel build has a nominal insulation build of approximately 3.0 milliradians (“mils”) (76.2 microns or μm).

The various wire samples were submerged in ATF at 200 °C for eight (8) hours. The ATF included 1.5% OCA-mine and 0.5% water by weight. Ten inch (10″) (25.4 centimeters (“cm”)) portions of the wire samples were bent into 7 successive loops with approximately the same diameters for each loop and then evaluated for cracks in the PI insulation. The wire loops were immersed into a container filled with the ATF, the container was sealed with the wires inside, and the container was then heated at 200 °C for 8 hours. Following heating, the container was cooled to room temperature within three (3) hours. The wire samples were taken out of the ATF, rinsed by acetone, and dried at 150 °C The samples where then evaluated via microscopic observation (at a magnification of 20-50 times) for cracks on each of the wire loops. The number of loops having one or more cracks were counted, with the cracking degree indicating the number of loops with cracks. For example, if a single loop had one or more cracks, the corresponding wire sample was determined to have a cracking degree of one (1). As another example, if three of the seven loops each had one or more respective cracks, the corresponding wire sample was determined to have a cracking degree of three (3). A higher cracking degree number implies poorer ATF resistance.

Table 1 compares the effects of utilizing different ATF resistant additives during the formation of PI magnet wire enamel insulation. As denoted in Table 1, wire samples with different additives were evaluated and compared to a control samples formed with PI having no additives. The fill rate of the additive was calculated from its loading content into the PI enamel sample. Between three and five samples were obtained and tested for category of additive indicated in Table 1.

TABLE 1
Evaluation of ATF Resistant Additives in PI Enamel Insulation

| | Fill Rate of | |
|---|---|---|
| | Additive | Cracking |
| | (Weight % in PI | Degree After |
| Additive | Layer) | ATF Testing |
| None (Control Sample) | 0% | 7 |
| N,N′-(1,4-phenylene)dimaleimide | 1.50% | 0 |
| (CAS Registry No. 3278-31-7) | | |
| 4,4′-bis(4-maleimididophenoxy)-1,1′-biphenyl | 2.33% | 1 |
| 1,1′-(3,3′-dimethoxyl-1,1′-biphenyl-4,4′- | 3.02% | 3 |
| diyl)bismaleimide | | |
| 4,4′-bismaleimido-2,2′-dimethylbiphenyl | 3.31% | 3 |
| 4,4′-bis(4-maleimidophenyl)ether | 3.16% | 5 |
| (CAS Registry No. 13132-94-0) | | |
| 4,4′-bismaleimidodiphenyl sulfone | 3.01% | 5 |
| (CAS Registry No. 126150-38-7) | | |
| 3,3′-bismaleimidodiphenyl sulfone | 3.00% | 6 |
| (CAS Registry No. 68555-55-5) | | |
| 3,4′-bismaleimidodipheylether | 3.22% | 7 |
| (CAS Registry No. 13132-94-0) | | |
| 1,1′-(3,3′-dimethyl-1,1′-biphenyl-4,4′-diyl)bismaleimide | 3.00% | 7 |
| (CAS Registry No. 13360-85-5) | | |
| 4,4′-bis(N-maleimido)benzophenone | 3.04% | 7 |
| (CAS Registry No. 76702-27-7) | | |
| 4-maleimido-4′-phtalimido-2,2′-dimethylbiphenyl | 7.12% | 7 |
| triallyl isocyanurate (“TAIC”) | 4.21% | 0 |
| (CAS Registry No. 1025-15-6) | | |
| tris(hydroxyethyl) cyanuric acid | 1.50% | 7 |
| (CAS Registry No. 839-90-7) | | |
| N,N′-(1,4-phenylene)dinadimide (PPD/BNI) | 1.51% | 0 |
| 4,4′-bisnadimido-2,2′-dimethylbiphenyl (MTLD/BNI) | 1.51% | 0 |
| 4,4′-bis(4-nadimidophenyl)ether (ODA/BNI) | 1.52% | 3 |
| 3,3′-bisnadimidodiphenyl sulfone (MDDS/BNI) | 1.86% | 6 |

As shown in Table 1, the addition of certain additives resulted in reduced cracking, degradation, or breakdown of PI insulation layers when exposed to ATF. In particular, as set forth in Table 1, additives such as TAIC, N,N′-(1,4-phenylene)dimaleimide, and 4,4′-bis(4-maleimididophenoxy)-1,1′-biphenyl, N,N′-(1,4-phenylene)dinadimide (“PPD/BNI”), 4,4′-bisnadimido-2,2′-dimethylbiphenyl (“MTLD/BNI”), 4,4′-bis(4-nadimidophenyl)ether (“ODA/BNI”), were found to exhibit excellent performance. Further, it is believed that fill rates of certain additives may be optimized in order to improve performance. It can be concluded that degradation of PI insulated magnet wire may be reduced as a result of utilizing ATF resistant additives.

In an exemplary embodiment, a magnet wire comprises: a conductor; and at least one insulation layer formed around the conductor, the insulation layer comprising: a base polyimide material; and one or more additives incorporated into the base polymeric material, the one or more additives comprising at least one unsaturated C═C-containing compound.

In an exemplary embodiment, the at least one unsaturated C═C-containing compound is referred to as an “ATF-resistant additive.”

In certain such exemplary embodiments, the ATF-resistant additive is selected from the group consisting essentially of: a maleimide, a nadimide, an itaconimide. In certain further exemplary embodiments, wherein the ATF-resistant additive comprises at least one maleimide, the ATF-resistant additive comprises one or more bismaleimides. In certain further exemplary embodiments, wherein the ATF-resistant additive comprises at least one nadimide, the ATF-resistant additive is selected from the group consisting essentially of a bisnadimide, and a bismethylnadimide. In certain further exemplary embodiments, wherein the ATF-resistant additive comprises at least one itaconimide, the ATF-resistant additive is selected from the group consisting essentially of an N-arylitaconimide, and a bisitaconimide.

In certain exemplary embodiments, the ATF-resistant additive comprises a vinyl or an allyl functional group.

In an exemplary embodiment, a magnet wire comprises: a conductor; and at least one insulation layer formed around the conductor, the insulation layer comprising: a base polyimide material; and one or more additives incorporated into the base polymeric material, the one or more additives comprising at least one unsaturated C═C-containing compound, wherein the one or more additives enhance resistance to automatic transmission fluid relative to a control insulation layer formed solely from the base polyimide material.

In certain exemplary embodiments, the one or more additives comprise a boiling point above 150 °C at ambient conditions.

In certain exemplary embodiments, the at least one unsaturated C═C-containing compound comprises one or multiple groups of: vinyl, allyl, maleimide, nadimide, or itaconimide. In further certain exemplary embodiments, the at least one unsaturated C═C-containing compound comprises one of: (i) an allyl isocyanurate or (ii) an allyl cyanurate. In still further exemplary embodiments, the at least one unsaturated C═C-containing compound comprises one of: triallyl isocyanurate, trimethallyl isocyanurate, triallyl cyanurate, triallyl trimellitate, tris[2-(acryloyloxy)ethyl]isocyanurate, or trimethallyl isocyanurate. In yet still further exemplary embodiments, the at least one unsaturated C═C-containing compound comprises one of: triallyl isocyanurate or trimethallyl isocyanurate. In certain exemplary embodiments, the at least one unsaturated C═C-containing compound comprises 2,2′-diallyl-bishpenol A.

In certain exemplary embodiments, the at least one unsaturated C═C-containing compound comprises one: of (i) a bismaleimide, (ii) a bisnadimide, (iii) a bismethylnadimide, or (iv) a bisitaconimide. In further certain exemplary embodiments, the at least one unsaturated C═C— containing compound comprises one of: (i) a bismaleimide-terminated monomer, (ii) a bisnadimide-terminated monomer, (iii) an N-aliphatic maleimide monomer, (iv) or an N-aliphatic nadimide monomer. In yet still further exemplary embodiments, the at least one unsaturated C═C— containing compound comprises one of: N-cyclohexyl maleimide, N-vinyl maleimide, N-ally maleimide, N-phenyl maleimide, N-biphenyl maleimide, N-benzophonone maleimide, N-(4-vinylphenyl)maleimide, N-(p-methylphenyl) maleimide, N-(benzyl) maleimide, diphenylmethane bismaleimide, diphenylsulfone bismaleimide, phenylene bismaleimide, bis(aminophenoxyphenyl)propane bismaleimide, oxydianiline bismaleimide, bismaleimidodimethylbiphenyl, 1,1′-(3,3′-dimethoxyl-1,1′-biphenyl-4,4′-diyl)bismaleimide, bis(aminophenoxy)benzene bismaleimides, bis(maleimidophenoxy) biphenyl, diaminodiphenyldetone bismaleimide, diaminodiphenyl sulfide bismaleimide, bis(maleimido) biphenyl, or bis(diaminodiphenylisopropylidimine)benzene bismaleimide.

In still yet further exemplary embodiments, the at least one unsaturated C═C— containing compound comprises one of: phenylene bismaleimide, diphenylsulfone bismaleimide, bis(maleimidophenoxy)biphenyl, bis(maleimido)biphenyl, bismaleimidodimethylbiphenyl, or diphenylmethane bismaleimide.

In certain exemplary embodiments, the at least one unsaturated C═C-containing compound comprises one of N-cyclohexyl nadimide, N-vinyl nadimide, N-ally nadimide, N-phenyl nadimide, N-biphenyl nadimide, N-benzophonone nadimide, N-(4-vinylphenyl) nadimide, N-(p-methylphenyl) nadimide, N-(benzyl) nadimide, diphenylmethane bisnadimide, diphenylsulfone bisnadimide, phenylene bisnadimide, bis(aminophenoxyphenyl)propane bisnadimide, oxydianiline bisnadimide, bisnadimidodimethylbiphenyl, 1,1′-(3,3′-dimethoxyl-1,1′-biphenyl-4,4′-diyl)bisnadimide, bis(aminophenoxy)benzene bisnadimide, bis(maleimidophenoxy) biphenyl, diaminodiphenyldetone bisnadimide, diaminodiphenyl sulfide bisnadimide, bis(nadimido) biphenyl, or bis(diaminodiphenylisopropylidimine)benzene bisnadimide.

In certain exemplary embodiments, the at least one unsaturated C═C-containing compound comprises one of N,N′-(1,4-phenylene)dinadimide, 4,4′-bisnadimido-2,2′-dimethylbiphenyl, 4,4′-bis(4-nadimidophenyl)ether, or 4,4′-bis(4-nadimidophenyl)ether.

In certain exemplary embodiments, the one or more additives comprise between 0.3% and 40.0% by weight of the at least one insulation layer. In further certain exemplary embodiments, the one or more additives comprise between 0.5% and 30.0% by weight of the at least one insulation layer.

In certain exemplary embodiments, the base polymeric material comprises a polyimide copolymer. In further certain exemplary embodiments, the polyimide copolymer comprises one of: polyamide-imide, polyester-imide, polysiloxane-imide, or polyurethane-imide.

An exemplary method of forming magnet wire comprises: providing a conductor; and forming at least one insulation layer around the conductor, the insulation layer comprising: a base polyimide material; and one or more additives incorporated into the base polymeric material, the one or more additives comprising at least one unsaturated C═C-containing compound, wherein the one or more additives enhance resistance to automatic transmission fluid relative to a control insulation layer formed solely from the base polyimide material.

In certain exemplary method embodiments, the one or more additives comprise a boiling point above 150 °C at ambient conditions In certain exemplary method embodiments, the at least one unsaturated C═C-containing compound comprises: one or multiple groups of vinyl, allyl, maleimide, nadimide, or itaconimide.

In certain exemplary method embodiments, the at least one unsaturated C═C— containing compound comprises one of: (i) an allyl isocyanurate or (ii) an allyl cyanurate. In further certain exemplary method embodiments, the at least one unsaturated C═C-containing compound comprises one of: triallyl isocyanurate, trimethallyl isocyanurate, triallyl cyanurate, triallyl trimellitate, tris[2-(acryloyloxy)ethyl]isocyanurate, or trimethallyl isocyanurate. In still further certain exemplary method embodiments, the at least one unsaturated C═C-containing compound comprises one of: triallyl isocyanurate or trimethallyl isocyanurate. In certain exemplary method embodiments, the at least one unsaturated C═C-containing compound comprises 2,2′-diallyl-bishpenol A.

In certain exemplary method embodiments, the at least one unsaturated C═C— containing compound comprises one of: (i) a bismaleimide, (ii) a bisnadimide, (iii) a bismethylnadimide, or (iv) a bisitaconimide. In certain further exemplary method embodiments, the at least one unsaturated C═C-containing compound comprises one of: (i) a bismaleimide-terminated monomer or (ii) a bisnadimide-terminated monomer, (iii) an N-aliphatic maleimide monomer, or (iv) an N-aliphatic nadimide monomer. In certain still further exemplary method embodiments, the at least one unsaturated C═C-containing compound comprises one of: N-cyclohexyl maleimide, N-vinyl maleimide, N-ally maleimide, N-phenyl maleimide, N-biphenyl maleimide, N-benzophonone maleimide, N-(4-vinylphenyl)maleimide, N-(p-methylphenyl) maleimide, N-benzyl maleimide, diphenylmethane bismaleimide, diphenylsulfone bismaleimide, phenylene bismaleimide, bis(aminophenoxyphenyl)propane bismaleimide, oxydianiline bismaleimide, bismaleimidodimethylbiphenyl, 1,1′-(3,3′-dimethoxyl-1,1′-biphenyl-4,4′-diyl)bismaleimide, bis(aminophenoxy)benzene bismaleimides, bis(maleimidophenoxy) biphenyl, diaminodiphenyldetone bismaleimide, diaminodiphenyl sulfide bismaleimide, bis(maleimido) biphenyl, or bis(diaminodiphenylisopropylidimine)benzene bismaleimide.

In certain exemplary method embodiments, the at least one unsaturated C═C— containing compound comprises one of phenylene bismaleimide, diphenylsulfone bismaleimide, bis(maleimidophenoxy)biphenyl, bis(maleimido)biphenyl, bismaleimidodimethylbiphenyl, or diphenylmethane bismaleimide.

In certain exemplary method embodiments, the at least one unsaturated C═C— containing compound comprises one of N-cyclohexyl nadimide, N-vinyl nadimide, N-ally nadimide, N-phenyl nadimide, N-biphenyl nadimide, N-benzophonone nadimide, N-(4-vinylphenyl) nadiimide, N-(p-methylphenyl) nadiimide, N-(benzyl) nadimide, diphenylmethane bisnadimide, diphenylsulfone bisnadimide, phenylene bisnadimide, bis(aminophenoxyphenyl)propane bisnadimide, oxydianiline bisnadimide, bisnadimidodimethylbiphenyl, 1,1′-(3,3′-dimethoxyl-1,1′-biphenyl-4,4′-diyl)bisnadimide, bis(aminophenoxy)benzene bisnadimides, bis(maleimidophenoxy) biphenyl, diaminodiphenyldetone bisnadimide, diaminodiphenyl sulfide bisnadimide, bis(nadiimido) biphenyl, or bis(diaminodiphenylisopropylidimine)benzene bisnadimide.

In certain exemplary method embodiments, the at least one unsaturated C═C— containing compound comprises one of N,N′-(1,4-phenylene)dinadimide, 4,4′-bisnadimido-2,2′-dimethylbiphenyl, 4,4′-bis(4-nadimidophenyl)ether, or 4,4′-bis(4-nadimidophenyl)ether.

In certain exemplary method embodiments, the one or more additives comprise between 0.3% and 40.0% by weight of the formed at least one insulation layer. In certain further exemplary method embodiments, the one or more additives comprise between 0.5% and 30.0% by weight of the formed at least one insulation layer.

In certain exemplary method embodiments, the base polymeric material comprises a polyimide copolymer. In certain further exemplary method embodiments, the polyimide copolymer comprises one of: polyamide-imide, polyester-imide, polysiloxane-imide, or polyurethane-imide.

In certain exemplary method embodiments, the forming the at least one insulation layer around the conductor step further comprises: applying a varnish containing the base polyimide material and the one or more additives; and curing the applied varnish at a temperature above 250 °C.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A magnet wire comprising:
a conductor; and
at least one insulation layer formed around the conductor, the insulation layer comprising:
a base polyimide material; and
one or more additives incorporated into the base polymeric material, the one or more additives comprising at least one unsaturated C═C-containing compound,
wherein the one or more additives enhance resistance to automatic transmission fluid relative to a control insulation layer formed solely from the base polyimide material.

2. The magnet wire of claim 1, wherein the one or more additives comprise a boiling point above 150 °C at ambient conditions.

3. The magnet wire of claim 1, wherein the at least one unsaturated C═C-containing compound comprises one or multiple groups of: vinyl, allyl, maleimide, nadimide, or itaconimide.

4. The magnet wire of claim 3, wherein the at least one unsaturated C═C-containing compound comprises one of: (i) an allyl isocyanurate or (ii) an allyl cyanurate.

5. The magnet wire of claim 4, wherein the at least one unsaturated C═C-containing compound comprises one of: triallyl isocyanurate, trimethallyl isocyanurate, triallyl cyanurate, triallyl trimellitate, tris[2-(acryloyloxy)ethyl]isocyanurate, or trimethallyl isocyanurate.

6. The magnet wire of claim 4, wherein the at least one unsaturated C═C-containing compound comprises one of: triallyl isocyanurate or trimethallyl isocyanurate.

7. The magnet wire of claim 3, wherein the at least one unsaturated C═C-containing compound comprises 2,2′-diallyl-bishpenol A.

8. The magnet wire of claim 1, wherein the at least one unsaturated C═C-containing compound comprises one: of (i) a bismaleimide, (ii) a bisnadimide, (iii) a bismethylnadimide, or (iv) a bisitaconimide.

9. The magnet wire of claim 8, wherein the at least one unsaturated C═C-containing compound comprises one of: (i) a bismaleimide-terminated monomer, (ii) a bisnadimide-terminated monomer, (iii) an N-aliphatic maleimide monomer, (iv) or an N-aliphatic nadimide monomer.

10. The magnet wire of claim 8, wherein the at least one unsaturated C═C-containing compound comprises one of: N-cyclohexyl maleimide, N-vinyl maleimide, N-ally maleimide, N-phenyl maleimide, N-biphenyl maleimide, N-benzophonone maleimide, N-(4-vinylphenyl)maleimide, N-(p-methylphenyl) maleimide, N-(benzyl) maleimide, diphenylmethane bismaleimide, diphenylsulfone bismaleimide, phenylene bismaleimide, bis(aminophenoxyphenyl)propane bismaleimide, oxydianiline bismaleimide, bismaleimidodimethylbiphenyl, 1,1′-(3,3′-dimethoxyl-1,1′-biphenyl-4,4′-diyl)bismaleimide, bis(aminophenoxy)benzene bismaleimides, bis(maleimidophenoxy) biphenyl, diaminodiphenyldetone bismaleimide, diaminodiphenyl sulfide bismaleimide, bis(maleimido) biphenyl, or bis(diaminodiphenylisopropylidimine)benzene bismaleimide.

11. The magnet wire of claim 8, wherein the at least one unsaturated C═C-containing compound comprises one of: phenylene bismaleimide, diphenylsulfone bismaleimide, bis(maleimidophenoxy)biphenyl, bis(maleimido)biphenyl, bismaleimidodimethylbiphenyl, or diphenylmethane bismaleimide.

12. The magnet wire of claim 8, wherein the at least one unsaturated C═C-containing compound comprises one of: N-cyclohexyl nadimide, N-vinyl nadimide, N-ally nadimide, N-phenyl nadimide, N-biphenyl nadimide, N-benzophonone nadimide, N-(4-vinylphenyl) nadimide, N-(p-methylphenyl) nadimide, N-(benzyl) nadimide, diphenylmethane bisnadimide, diphenylsulfone bisnadimide, phenylene bisnadimide, bis(aminophenoxyphenyl)propane bisnadimide, oxydianiline bisnadimide, bisnadimidodimethylbiphenyl, 1,1′-(3,3′-dimethoxyl-1,1′-biphenyl-4,4′-diyl)bisnadimide, bis(aminophenoxy)benzene bisnadimide, bis(maleimidophenoxy) biphenyl, diaminodiphenyldetone bisnadimide, diaminodiphenyl sulfide bisnadimide, bis(nadimido) biphenyl, or bis(diaminodiphenylisopropylidimine)benzene bisnadimide.

13. The magnet wire of claim 8, wherein the at least one unsaturated C═C-containing compound comprises one of: N,N′-(1,4-phenylene)dinadimide, 4,4′-bisnadimido-2,2′-dimethylbiphenyl, 4,4′-bis(4-nadimidophenyl)ether, or 4,4′-bis(4-nadimidophenyl)ether.

14. The magnet wire of claim 1, wherein the one or more additives comprise between 0.3% and 40.0% by weight of the at least one insulation layer.

15. The magnet wire of claim 1, wherein the one or more additives comprise between 0.5% and 30.0% by weight of the at least one insulation layer.

16. The magnet wire of claim 1, wherein the base polymeric material comprises a polyimide copolymer.

17. The magnet wire of claim 16, wherein the polyimide copolymer comprises one of: polyamide-imide, polyester-imide, polysiloxane-imide, or polyurethane-imide.
